(19) United States
(12) Patent Application Publication
(10) Pub. No.: US 2025/0162205 A1
(43) Pub. Date: May 22, 2025

(54) MOULD FOR A CURVED PANEL

(71) Applicant: COEXPAIR, Namur (BE)

(72) Inventor: André BERTIN, Vedrin (BE)

(21) Appl. No.: 18/838,216

(22) PCT Filed: Feb. 13, 2023
(86) PCT No.: PCT/EP2023/053440

§ 371 Date: Aug. 13, 2024

(30) Foreign Application Priority Data
Feb. 14, 2022 (EP) 22156544.3

(51) Int. Cl. B29C 33/30; B29C 33/04

(52) U.S. Cl. CPC B29C 33/307; B29C 33/04; B29C 33/305

(57) ABSTRACT

The present disclosure relates to a mould for moulding a curved part having a large dimension. The mould comprises a first portion, a second portion, bearing devices and slide zones located between the first portion and one of the bearing devices, and between the second portion and the other of the bearing devices. The mould allows the first portion and the second portion to slide horizontally while the bearing devices apply a vertical pressure thereto.

### CROSS-REFERENCE TO RELATED APPLICATION(S)

This present application is a national stage application of International Patent Application No. PCT/EP2023/053440, filed Feb. 13, 2023, which claims priority to European Patent Application No. 22156544.6, filed Feb. 14, 2022, the disclosures of which are hereby incorporated by reference in their entireties.

### TECHNICAL FIELD

The present disclosure concerns a mould for moulding and polymerizing under pressure a panel made of composite material which is curved and having a large dimension.

### BACKGROUND

A composite material comprises one or several reinforcement(s) impregnated with a polymerized resin.

A known mould making it possible to mould a curved panel having a large dimension made of composite material, for example an airfoil panel for an aircraft wing, comprises a moulding surface on the one hand and a vacuum membrane or bag on the other hand. The pressure exerted for the moulding is in some cases the atmospheric pressure, via the evacuation between the mould and the bag or membrane, or in other cases is increased thanks to an autoclave, typically between 6 and 8 bars. A pressure of 6 to 8 bars is usually necessary to limit the porosity of the composite to acceptable values, typically below 2% of the volume. The mould is heated to polymerize the resin of the composite material, typically at 180° C. The permitted heating rate is generally 3° C./minute but it is most often limited to 1° C./minute for the autoclave curing in order to maintain a thermal homogeneity throughout the mould and the part to be produced. We typically aim for a homogeneity of +/−5° C. on the whole.

Most often the resin is either already present in the reinforcement when the mould is closed by the vacuum membrane or bag, or it is injected there after evacuation. In some cases the resin is partially present during the evacuation and a complement is injected.

Furthermore, if the part incorporates projecting elements, for example stiffeners, these are generally formed upwards, opposite the moulding surface, by an external device located under the vacuum bag whose positioning relative to the moulding surface is difficult.

An alternative to curing under pressure and temperature, in an autoclave, on a single-sided mould closed by a vacuum bag, is a method called SQRTM—Same Qualified Resin Transfer moulding —, which is known to allow curing under pressure and temperature in a male/female, double-sided mould. This SQRTM method makes it possible to reproduce the pressure and temperature levels of an autoclave method. The SQRTM makes it possible to produce a composite of a quality at least equivalent to that of a composite produced in an autoclave.

Many methods exist for injecting resin during the moulding of a composite panel. The method is generally called RTM—Resin Transfer moulding and is available in many variations depending on whether vacuum, external pressure on the mould, a single-sided mould with a vacuum bag or a male/female mould are involved, depending on when the mould is completely closed. Better quality parts are generally obtained in male/female moulds where vacuum is applied before a pressure injection.

The use of an autoclave to apply a closing pressure to a mould and heat it is known to be a method that is not very energy efficient (it requires heating a gas which heats a mould by convection) and consumes accessory materials such as vacuum bags that are discarded after each use or membranes that are discarded after a few uses.

In the case of an aircraft airfoil panel, the reinforcement of the composite material is carbon fiber, the resin is most often an epoxy. The particularity of carbon fiber is that it expands very little during the moulding cycle, between 20° C. and 180° C. It is common to mould parts having large dimensions on single-sided moulds made of materials whose thermal expansion is close to that of carbon fiber such as Invar steel or a composite based on carbon fiber. Invar is an expensive material. A composite based on carbon fiber is relatively fragile as materials for a mould. It has been shown that during moulding by SQRTM or RTM of parts having large dimensions, in male/female mould, under pressure and temperature, that it is possible to dispense with the use of a mould material whose expansion coefficient is close to that of carbon fiber. Typically aluminum or steel moulds are used.

### SUMMARY

An object of the present disclosure is to provide a mould for a part such as a panel made of composite material, curved and having a large dimension, polymerized under pressure and temperature. This mould allows excellent control of the thickness of the panel and of the position of any projecting elements. This mould can also be made of materials whose expansion coefficient is significantly different from that of the reinforcement of the composite part, for example steel or aluminum for a carbon fiber reinforcement. The mould according to the disclosure makes it possible to manufacture high quality parts at an interesting yield.

To this end, the disclosure proposes a mould for moulding at least one portion of a curved part, the part having a first part surface and a second part surface separated by a thickness, the mould comprising:
a shell comprising:
   a first portion comprising a first moulding surface for moulding the first part surface, and a first outer surface opposite the first moulding surface,
   a second portion comprising a second moulding surface for moulding the second part surface, and a second outer surface opposite the second moulding surface, at least one of the first and second outer surfaces being non-planar;
a bearing system comprising:
   a first bearing device mechanically coupled to the first portion of the shell and configured to press on the first portion of the shell in a first direction, and
   a second bearing device mechanically coupled to the second portion of the shell and configured to press on the second portion of the shell in the first direction;
   the mould being configured to allow, between the first portion of the shell and the first bearing device, and between the second portion of the shell and the second bearing device, sliding in at least one direction perpendicular to the first direction.

In the mould according to the disclosure, each of the first and second surfaces of the part is defined by one of the moulding surfaces, and the thickness of the part is defined by the distance between the moulding surfaces of the mould. The mould is preferably such that sliding is possible in any direction perpendicular to the first direction.

Since the first portion of the shell slides relative to the first bearing device and the second portion of the shell slides relative to the second bearing device in at least one direction perpendicular to the first direction, the stress exerted by the bearing devices on the moulding surfaces is only in the first direction. This makes it possible to take up the pressure in the first direction while leaving the movement free in at least one perpendicular direction. Thus, when, during moulding, the temperature of the moulding surfaces increase and they expand, the moulding surfaces have the freedom to extend perpendicularly to the first direction while they are constrained in the first direction. Consequently, the thermal expansion of the moulding surfaces mainly results in a deformation perpendicular to the first direction, and the thickness of the part, that is to say its extension in the first direction, is extremely well controlled despite the thermal expansion thanks to the pressure in the first direction. For example, if the first direction is vertical, it can be considered that the shell slides horizontally between bearing devices which remain fixed horizontally. Consequently, the thermal expansion of the moulding surfaces mainly results in an increase in the gap between the bearing devices, this gap (and therefore the thickness of the part) is extremely well controlled thanks to the pressure exerted by a tightening device on the bearing system. During moulding, the thickness of the part is thus controlled by pressing in the first direction.

During moulding, the injected resin exerts a pressure tending to cause the first and second portions of the shell to move apart. With the mould according to the disclosure, this outward pressure is mainly counteracted by a tightening device which exerts an inward pressure through the bearing system. The balance between outward and inward pressures makes it possible to obtain the desired part thickness.

The moulding is carried out at a temperature between 120°° C. and 180° C. under a pressure of 5 to 10 bars. Typically, the vacuum level inside the shell is less than 10 mbar.

The mould is configured so that the mechanical coupling between the first bearing device and the first portion of the shell transmits a pressure in the first direction from the first bearing device to the first portion of the shell, and so that the mechanical coupling between the second bearing device and the second portion of the shell transmits a pressure in the first direction from the second bearing device to the second portion of the shell.

The pressure transfer and the sliding between the first portion of the shell and the first bearing device occur on a plurality of first slide zones, and the pressure transfer and the sliding between the second portion of the shell and the second bearing device occur on a plurality of second slide zones.

Preferably, the pressure is only put on a portion of the outer surfaces of the first portion of the shell, and of the second portion of the shell, this portion representing less than 20% of the outer surface. In other words, the first slide zones represent less than 20% of the outer surface and the second slide zones represent less than 20% of the outer surface. This makes it possible to obtain a particularly light mould.

The shell is provided so that its first portion and its second portion do not slide, or slide only slightly, relative to each other during moulding. The first portion of the shell is preferably a female portion and the second portion is preferably a male portion. However, the opposite is possible while remaining within the scope of the disclosure.

The non-planarity of the outer surfaces allows them to follow, at least partially, the curved shape of the moulded part, or of the moulded portion of the part. This allows the shell to be particularly light and therefore particularly easy to heat. The same applies to the non-coplanarity of the slide zones.

The moulding by SQRTM or RTM in a double-sided mould like the shell of the disclosure, under pressure and temperature, makes it possible to dispense with the use of an autoclave. A benefit is that the thickness of the part is better controlled than in an autoclave because it is defined by the air gap of the mould and not by the pressure exerted by the autoclave to limit the porosity. Thanks to the bearing system, the double-sided mould according to the disclosure is sufficiently stiff so that the air gap does not vary excessively in reaction to the pressure exerted inside the mould. Another way to obtain a sufficient stiffness would be to use a stiff shell as such, but such a shell is particularly massive, which increases the energy required to heat it.

The first direction is preferably such that it takes up most of the pressure exerted by the reinforcement and the resin on the inside of the mould during moulding.

The first direction is preferably vertical, but it could be arbitrary (for example horizontal) while remaining within the scope of the disclosure. The part extends mainly in the second and third directions and its thickness extends mainly in the first direction.

The part preferably comprises a panel. The mould according to the disclosure is particularly suitable for parts which are or which comprise panels of at least 1 m², for example of at least 10 m². It may have a length, measured in the second direction, of at least 5 m, for example at least 12 m. It may have a width, measured in the third direction, of at least 1 m, for example at least 2 m.

The part is curved. For example, it may have a negative bend point, which indicates a “saddle” geometry. The hollow in the part can have a depth of at least 30 cm, for example at least 80 cm.

The bearing devices can be made of steel or carbon fiber, for example. Carbon fiber makes it possible to reduce mass and thermal expansion.

The first and second slide zones preferably comprise one or several material(s) such that the static friction coefficient, us, is less than 0.5 for the sliding between the first portion of the shell and the first bearing device, and between the second portion of the shell and the second bearing device.

According to one embodiment, the mechanical coupling between the first outer surface and the first bearing device comprises protrusions extending from the first outer surface to the first bearing device and/or protrusions extending from the first bearing device to the first outer surface; and the mechanical coupling between the second outer surface and the second bearing device comprises protrusions extending from the second outer surface to the second bearing device and/or protrusions extending from the second bearing device to the second outer surface. Thus, the contact between the bearing devices and the first and second portions of the shell does not extend over the entire surface of the shell. This allows the mould to be particularly light. The pressure in the first direction is transmitted via the protrusions.

According to one embodiment, at least some of the protrusions comprise ridges. This allows a particularly homogeneous pressure transfer. The ridges form the contact lines between the shell and the bearing system. In addition, the ridge-like protrusions of the outer surfaces allow the shell to be stiffened. However, it is possible, while remaining within the scope of the disclosure, for at least some of the protrusions to have another form, for example rods or posts.

According to one embodiment, the mould comprises heating elements fastened to the first outer surface, and/or to the second outer surface, and/or to the bearing system, and located between protrusions. The heating elements can for example be electrical resistors or magnetic inductors inducing eddy currents in the shell. The arrangement of the heating elements as close as possible to the outer surfaces of the shell makes it possible to consume particularly little energy since the thermal transfer is particularly effective.

In one embodiment of the disclosure, the bearing system comprises passages configured to pass a thermal transfer fluid. The fluid can for example be a gas, in particular air, passing through holes of walls forming the protrusions. Cooling can be passive or by forced convection. The fluid can be a liquid, in particular if the mould comprises an active cooling system between the moulding surfaces and the bearing system. The active cooling system can for example comprise pipes located between the first thermal insulation and in which the cooled liquid circulates. Gas and liquid cooling can be combined.

According to one embodiment, the mechanical coupling between the first outer surface and the first bearing device and the mechanical coupling between the second outer surface and the second bearing device comprises a first thermal insulation. Thus the thermal transmission between the shell and the bearing system is particularly low. This makes it possible to consume particularly little energy since the mass of material to be heated is limited to the shell which is light. In addition, it prevents the bearing system from thermally deforming. The first thermal insulation may for example be made of a material having a thermal conductivity lower than 0.5 W m⁻¹ K⁻¹, for example made of a laminated material based on glass fibers and resin such as Glastherm. It is also possible for the bearing devices to be made of a thermally insulating material, for example made of carbon fiber composite.

According to one embodiment, the sliding between the first portion of the shell and the first bearing device occurs on a plurality of first slide zones and the sliding between the second portion of the shell and the second bearing device occurs on a plurality of second slide zones, the mould being configured so that the distance in the first direction between the first slide zones and the second slide zones varies by less than 20% over the entire mould. Thus, the distance in the first direction between the junction points of the shell and the bearing system varies by less than 20% over the entire mould. This allows a particularly uniform application of the pressure in the first direction because when the shell expands over its thickness all the slide zones move apart in the first direction in the same way (which is taken up by the tightening device) and contact is not lost anywhere.

The distance between the elements of the shell is not constant over the entire mould. Indeed, the thickness of the part can vary between two places of the mould.

According to one embodiment, the first portion of the shell comprises a first segment and a second segment assembled by mechanical fastener outside the first moulding surface and by a weld along the first moulding surface; and/or the second portion of the shell comprises a first segment and a second segment assembled by a mechanical fastener outside the second moulding surface and by a weld along the second moulding surface. Having several segments facilitates the manufacture and transport of the mould, and makes it possible to separate a single segment from the first portion of the shell or from the second portion of the shell if we want to carry out a modification therein or in the case of a failure of a portion of the shell. The mechanical assembly, for example by bolting, allows a particularly resistant and precise separable fastening. The surface weld allows the moulding surface to be airtight. The weld preferably has a maximum thickness of 10 mm. It can be carried out by laser. Each of the segments preferably has a length of less than 10 meters. The weld is broken during the separation of the segments.

According to one embodiment, the shell comprises cavities in the first moulding surface and/or the second moulding surface. The cavities make it possible to place projecting reinforcements, which, after moulding (therefore polymerization of the resin), will form projecting elements of the part, for example stiffeners.

The cavities are preferably only in the first moulding surface, and the second portion of the shell has none. If the first portion is located below the second portion, this allows the complexity to be in the first portion, which is heavier but whose handling is limited during the moulding process, and the second portion, which is removable and subject to more handling, to be simpler and lighter.

According to one embodiment, the mould comprises removable inserts located in the cavities, each insert comprising an open space intended to receive a projecting reinforcement. With the polymerized resin, the projecting reinforcement will constitute after moulding a projecting element of the part, typically a stiffener. The inserts can for example be made of the same material as the shell. They may comprise at least two portions removable relative to each other. The inserts facilitate the moulding of the projecting elements as well as their demoulding.

According to one embodiment, the mould comprises removable arms configured to carry the inserts and to be inserted, at least partially, into grooves of the first moulding surface, and/or of the second moulding surface. The arms allow to take the inserts in which are the reinforcements which will constitute the projecting elements, stiffener or other component of the part, on the system where they were prepared while maintaining their respective positions to deposit them in the mould. This makes it possible to segment inserts which would have a significant length and to prepare them by arranging them at precise relative positions. A precise clearance between insert segments can be defined so that once positioned in the mould and brought to a given temperature, this clearance between segments disappears under the effect of the thermal expansion of the inserts, without damaging the reinforcements which are disposed therein.

The arms allow precise installation of the cold inserts and the reinforcements they contain in a previously heated moulding surface, for example between 90 and 120° C. A reinforcement can then be placed on the moulding surface and the inserts before the other moulding surface is placed. It too may have been preheated. This solution saves time to produce the part, most of the mass to be heated having been preheated. Once the part polymerized, for example at 180° C., the arms make it possible to demould the part easily and to quickly release the moulding device which can then be used to mould another part.

The disclosure further proposes a system comprising a mould, a tightening device, and a resin injection system configured to inject a resin between the first moulding surface and the second moulding surface, preferably into and/or around at least one reinforcement located between the first moulding surface and the second moulding surface. The at least one reinforcement comprises the main reinforcement and optionally one or several other reinforcements, for example projecting reinforcements. In the case of the RTM method, the resin is injected into the at least one reinforcement. In the SQRTM method, the resin is injected around the at least one reinforcement before polymerization to control the pressure in the resin during the moulding process. The mould according to the disclosure is intended to operate for example with a pneumatic tightening device in which the force is transmitted by a compressed gas. The pressure is preferably applied vertically upwards by a lower portion of the tightening device (as illustrated in the figures). The tightening device can be partially fastened to the bearing system or integral with the first bearing device on one side and with the second bearing device on the other side.

According to one embodiment, the pressure applied by the tightening device can be controlled by zones which makes it possible to apply a different pressure to the edges of the shell compared to the center of the shell. The pressures applied can vary during the moulding to facilitate the injection of resin and/or to obtain the desired thicknesses during the polymerization of the resin.

The disclosure further proposes a moulding method comprising heating a resin and a main reinforcement in a mould according to the disclosure, so as to mould a composite part, incorporating the main reinforcement and resin, and whose first part surface is moulded against the first moulding surface and the second part surface is moulded against the second moulding surface. During heating, resin is preferably injected between the first moulding surface and the second moulding surface, and a pressure in the first direction is applied via the bearing system. The method can be, for example, resin transfer moulding without prior impregnation of the reinforcement (RTM) or with prior impregnation of the reinforcement (SQRTM). The method may not comprise resin injection (for example a method called “compression moulding”), if the quantity of resin already present is such that the desired pressure is reached even without injection. Heating the resin present in the reinforcement allows it to polymerize. The heating is preferably carried out via the heating of the shell. The heating makes it possible, for example, to reach a temperature between 120° C. and 180° C. The pressure makes it possible in particular to prevent degassing of the resin, or even boiling, which would lead to an unacceptable porous part. The injection is preferably carried out under a pressure between 5 and 10 bars.

According to one embodiment, the part is or comprises an airfoil panel for an aircraft wing, an aircraft empennage, an aircraft fuselage panel, an aircraft airfoil flap, an aircraft fairing or aircraft engine part.

According to one embodiment, the airfoil may comprise an upper panel manufactured in a mould according to the disclosure, and a lower panel manufactured in another mould according to the disclosure. According to another embodiment, the upper panel and the lower panel are manufactured in the same mould: the upper panel against one of the moulding surfaces of the shell, and the lower panel against the other of the moulding surfaces of the shell.

According to one embodiment, the method comprises, prior to the injection of resin, inserting the inserts into the cavities and inserting the projecting reinforcements into the open spaces of the inserts, so that the projecting reinforcements, the main reinforcement and the resin are united by the moulding so as to form the part. The precision of the inserts and their positioning mean that the projecting elements have a particularly well-defined shape.

According to one embodiment, the shell is at a temperature greater than 40° C., for example between 90° C. and 120° C., when the inserts are inserted into the cavities. For example, the shell can be maintained above 40° C., for example between 90° C. and 120° C., between successive mouldings. This makes it possible to reduce the amount of energy needed to increase the temperature of the shell.

According to one embodiment, the heating takes place during:

a period during which the pressure in the first direction is uniform over the entire shell, and at least one other period during which the pressure in the first direction on a central shell zone is different from the pressure on a peripheral shell zone.

### BRIEF DESCRIPTION OF THE DRAWINGS

Other features and advantages of the disclosure will appear on reading the following detailed description for the understanding of which reference will be made to the appended figures among which:

FIG. 1 is a vertical schematic view of a shell,

FIG. 2 is a vertical schematic view of a moulding system,

FIG. 3 is a vertical schematic view of a portion of a mould,

FIGS. 4a and 4b illustrate, respectively, first and second bearing devices,

FIG. 5 is a schematic view of an assembly between several segments of a first portion and a second shell portion,

FIG. 6a is a top view of a second shell portion,

FIG. 6b is a bottom view of a second shell portion,

FIG. 7 is a top view of a first shell portion,

FIG. 8 is a vertical view illustrating an insert in a cavity of a first portion of a mould,

FIG. 9 is a schematic top view of projecting reinforcements and inserts,

FIG. 10 is a schematic top view of projecting reinforcements and inserts on a first portion of the shell,

FIG. 11a is a schematic vertical section of projecting reinforcements and inserts on a first portion of the shell, before injection,

FIG. 11b is a schematic vertical section of a part in a mould being opened, after injection, and

FIG. 11c is a schematic vertical section of a moulded part.

### DETAILED DESCRIPTION

The present disclosure is described with specific embodiments and references to figures, but the disclosure is not limited thereby. The drawings or figures described are only schematic and are not limiting. In addition, the functions described may be carried out by other structures than those described in the present document.

In the context of the present document, the terms “first” and “second” only serve to differentiate the various elements and do not imply an order between these elements.

In the figures, identical or similar elements may have the same references.

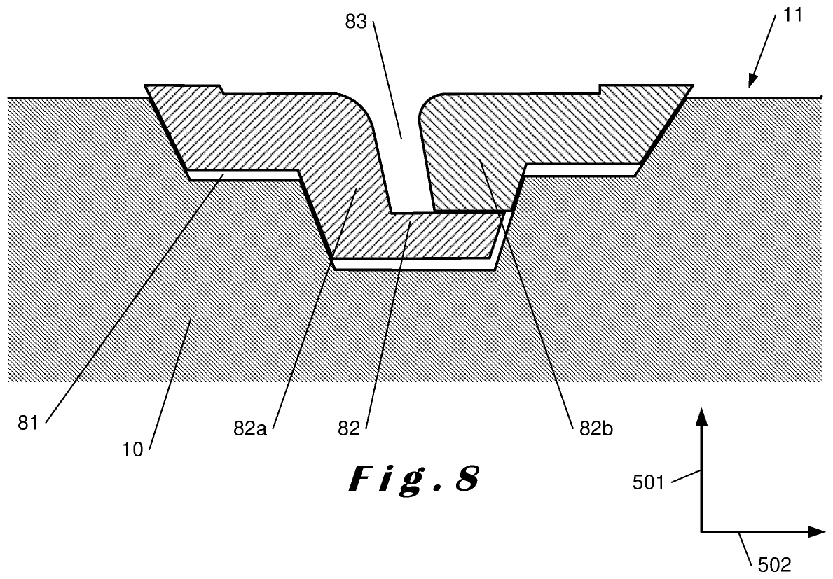

The various elements of the disclosure are described with reference to first 501, second 502, and third 503 directions. The second 502 and third 503 directions are perpendicular to the first direction 501 and are preferably mutually perpendicular. The references 501, 502 and 503 are indicated in particular in FIG. 8. The figures correspond to an embodiment of the disclosure where the first direction 501 is vertical.

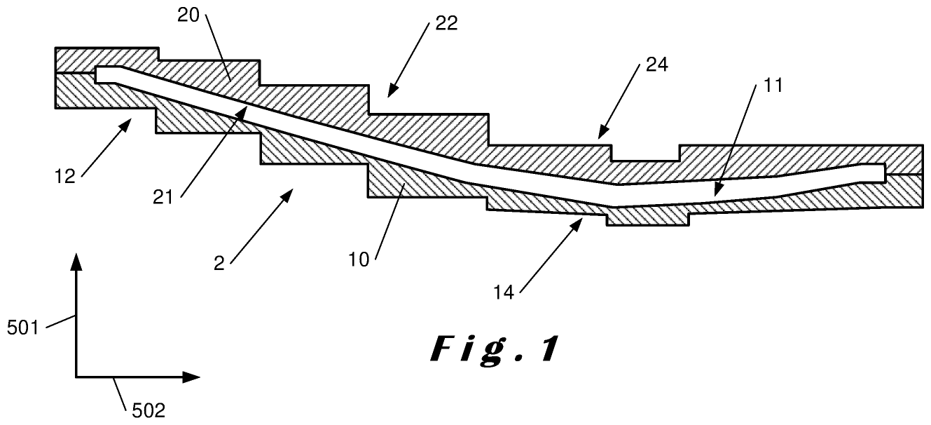

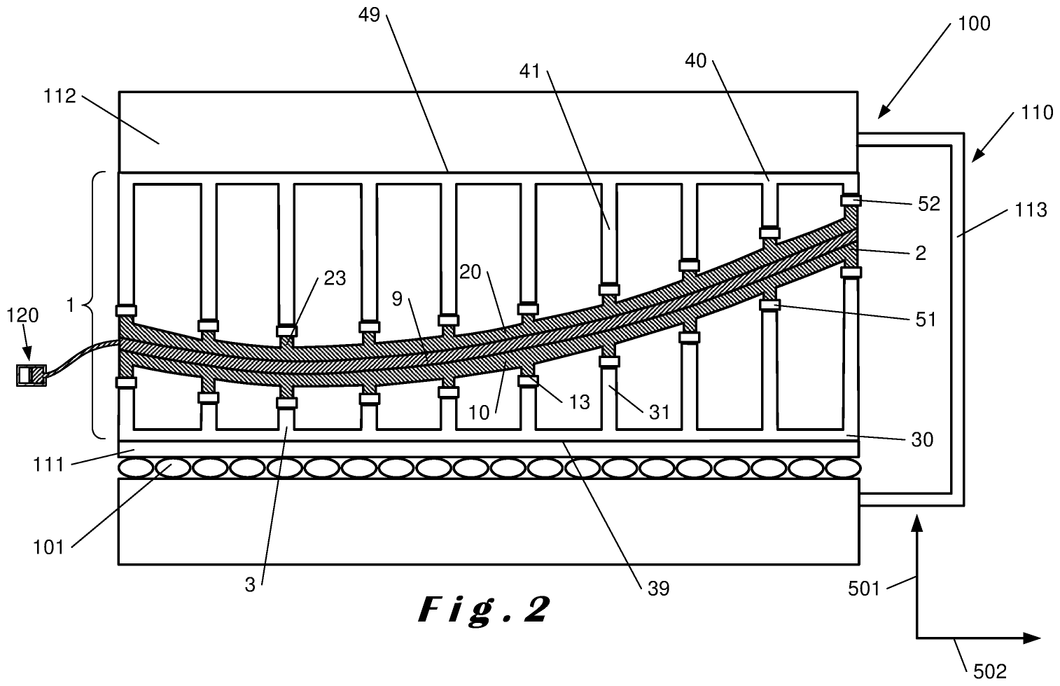

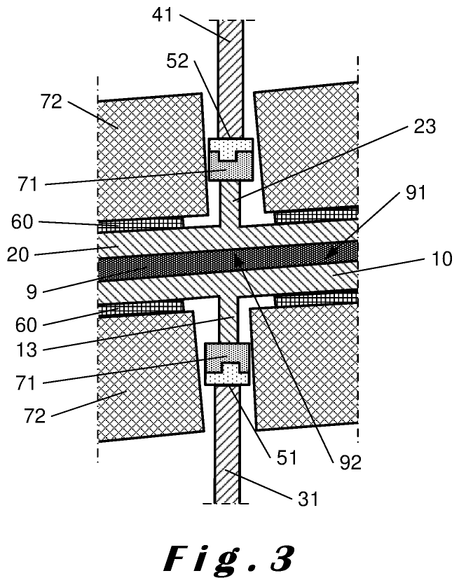

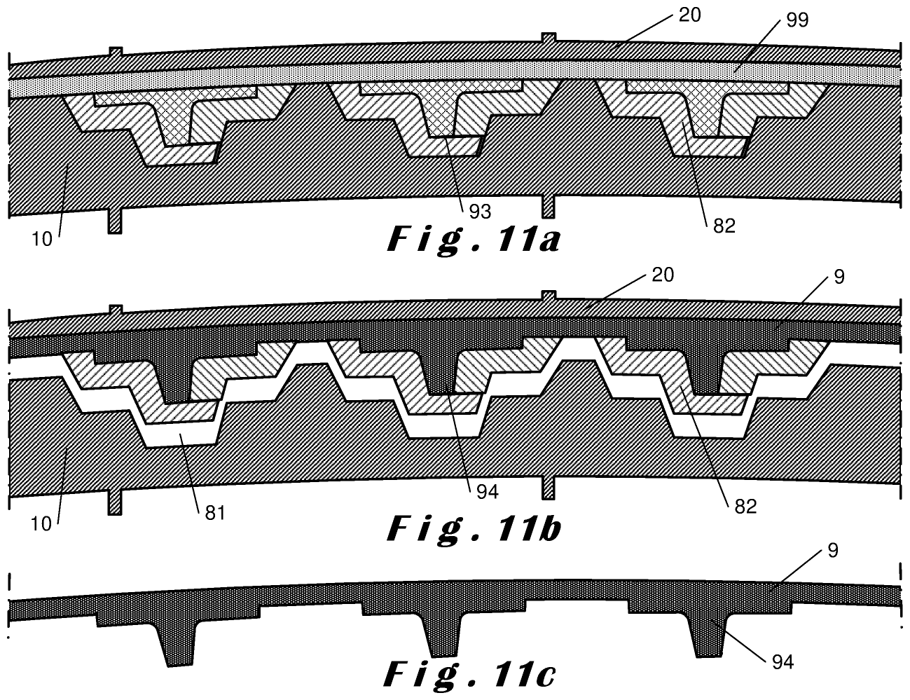

FIG. 1 is a vertical schematic view of a shell 2 intended to be used in a mould 1 according to one embodiment of the disclosure. The shell 2 comprises a first portion 10 and a second portion 20. When the first direction 501 is vertical, the first portion 10 and the second portion 20 are essentially horizontal, and the first portion 10 is intended to be below the second portion 20. The first portion 10 comprises a first moulding surface 11, and the second portion 20 comprises a second moulding surface 21, which together define the shape of a part 9 (FIGS. 2 and 3) which will be moulded by the mould 1. The part 9, once moulded, incorporates a main reinforcement 99, projecting reinforcements 93 (FIG. 11a) and polymerized resin. The main reinforcement 99 and the projecting reinforcements 93 are made of carbon fibers.

The first moulding surface 11 makes it possible to mould the first part surface 91 of the part 9 and the second moulding surface 21 makes it possible to mould the second part surface 92 of the part 9. The shell 2 is provided so that, on its periphery, the first portion 10 and the second portion 20 do not slide, or slide only slightly, relative to each other. For example, the friction between them at the left and right ends of FIG. 1 may be sufficient to prevent sliding.

The first portion 10 comprises a first outer surface 12 opposite the first moulding surface 11, and the second portion 20 comprises a second outer surface 22 opposite the second moulding surface 21. The first outer surface 12 and/or the second outer surface 22 are non-planar so as to follow, at least partially, the bending of the part 9. The first outer surface 12 preferably comprises facets 14 perpendicular to the first direction 501, and/or the second outer surface 22 preferably comprises facets 24 perpendicular to the first direction 501.

FIG. 2 is a vertical schematic view of a moulding system 100 according to one embodiment of the disclosure. The moulding system 100 comprises a mould 1 and a tightening device 110, for example, pneumatic or hydraulic, comprising beads 101 provided to receive a fluid in order to apply a pressure in the first direction 501 on the mould 1. The mould 1 comprises the shell 2, and a bearing system 3. The moulding system 100 also comprises, preferably, a resin injection system 120 configured to inject a resin between the first moulding surface 11 and the second moulding surface 21.

The bearing system 3 comprises a first bearing device 30 configured to press in the first direction 501 on the first portion 10, via first slide zones 51, and a second bearing device 40 configured to press in the first direction 501 on the second portion 20, via second slide zones 52. The first slide zones 51 are not in the same plane and/or the second slide zones 52 are not in the same plane.

The first slide zones allow sliding perpendicular to the first direction 501 between the first portion 10 and the first bearing device 30, and transmit the pressure in the first direction 501 from the first bearing device 30 to the first portion 10. The second slide zones allow sliding perpendicular to the first direction 501 between the second portion 20 and the second bearing device 40, and transmit a pressure in the first direction 501 from the second bearing device 40 to the second portion 20.

In one embodiment of the disclosure, the first outer surface 12 comprises protrusions 13 extending downwards, the first bearing device 30 comprises protrusions 31 extending upwards, and the first slide zones are at the interface between the protrusions 13 of the first outer surface 12 and the protrusions 31 of the first bearing device 30.

In one embodiment of the disclosure, the second outer surface 22 comprises protrusions 23 extending upwards, the second bearing device 40 comprises protrusions 41 extending downwards, and the second slide zones are at the interface between the protrusions 23 of the second outer surface 22 and the protrusions 41 of the second bearing device 40.

Preferably, the distance in the first direction 501 between the first slide zones and the second slide zones varies by less than 20% over the entire mould 1.

The first bearing device 30 comprises a flat outer surface 39, oriented opposite the shell 2, which is perpendicular to the first direction 501. The flat outer surface 39 is in contact or is integral with a first portion 111 of the tightening device 110. The second bearing device 40 comprises a flat outer surface 49, oriented opposite the shell 2, which is perpendicular to the first direction 501. The flat outer surface 49 is in contact or is integral with a second portion 112 of the tightening device 110. The first portion 111 of the tightening device 110 and the second portion 112 of the tightening device 110 are mechanically coupled 113.

FIG. 3 is a vertical schematic view of a portion of a mould 1 according to one embodiment of the disclosure. It makes it possible to illustrate some optional features of the disclosure, in particular heating elements 60 located between the protrusions 13, 23 of the shell 2, a first thermal insulation 71 located at the slide zones 51, 52, and a second thermal insulation 72 located on the heating elements 60 opposite the shell 2. The second thermal insulation 72 may be for example made of a material having a thermal conductivity lower than 0.5 W m-1 K-1, for example made of glass wool.

The heating elements 60 are preferably against the outer surfaces 12, 22, in particular in the case of conduction heating. The heating elements 60 preferably face the outer surfaces 12, 22 in the case of radiative or inductive heating.

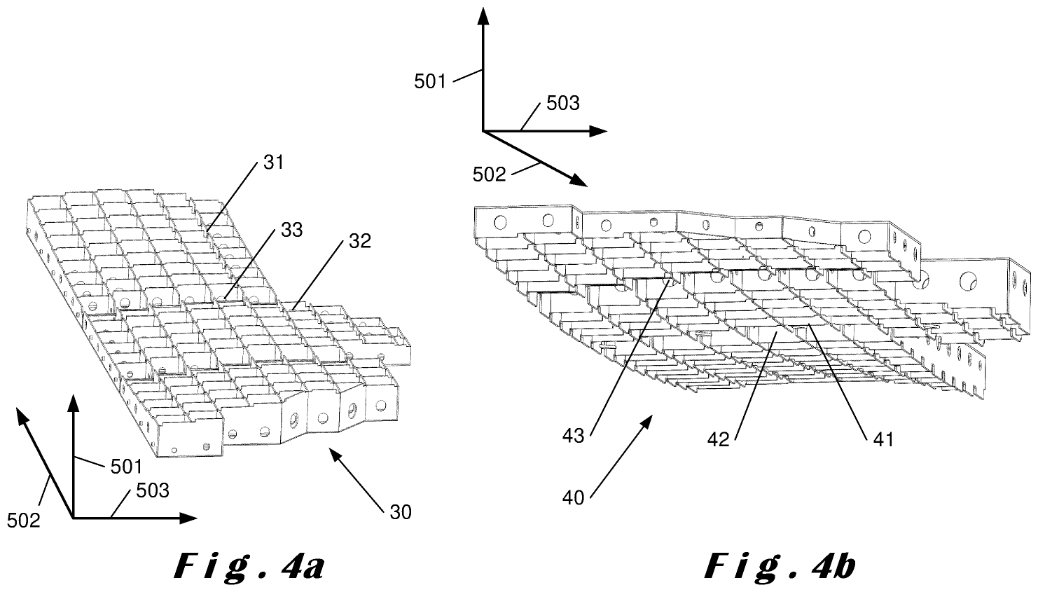

FIGS. 4a and 4b illustrate, respectively, the first 30 and second 40 bearing devices in an embodiment of the disclosure in which the protrusions 31, 41 of the bearing devices 30, 40 are ridges. The protrusions 31, 41 form walls delimiting compartments 32, 42 or boxes. These walls are preferably traversed by holes creating passages 33, 43 between the compartments 32, 42. Such an architecture of the bearing devices 30, 40 allows them to be particularly light, which makes it possible in particular to facilitate their handling. This also makes it possible to dissipate heat thanks to the circulating air, for example by forced convection, and thanks to a thermal transfer fluid system.

In general, it is preferred that the bearing devices 30, 40 be at least 50% hollow. In other words, at least 50% of the volume occupied by each of the bearing devices 30, 40 is not made of a solid material.

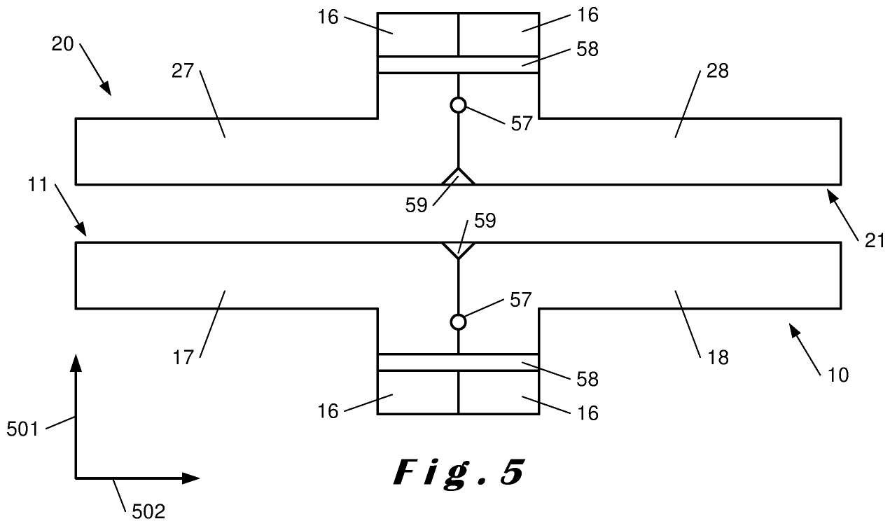

FIG. 5 is a schematic view of an assembly between first 17 and second 18 segments of the first portion 10, and of an assembly between first 27 and second 28 segments of the second portion 20 in one embodiment of the disclosure. Each of the assemblies comprises a mechanical fastener 58 which is located outside the moulding surface 11, 21, and/or a weld 59 which is located at least on the moulding surface 11, 21. The mechanical fastener 58 and the weld 59 are preferably spatially separated from each other. The mechanical fastener 58 may for example comprise flanges 16, 26 through which bolts pass. The weld 59 may have a triangular longitudinal section. The interface between the segments 17, 18 or 27, 28 may comprise a seal 57.

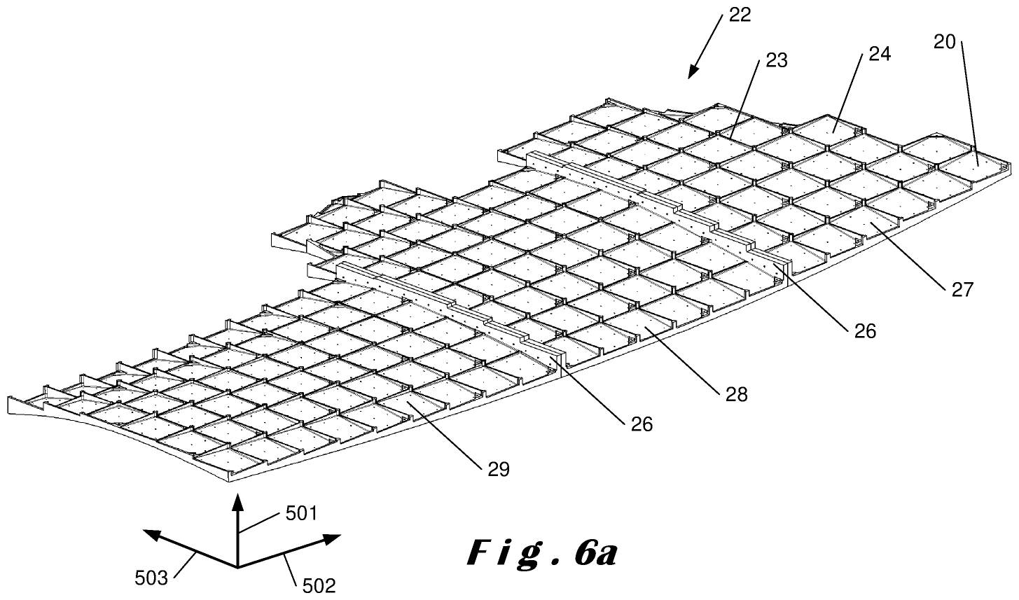

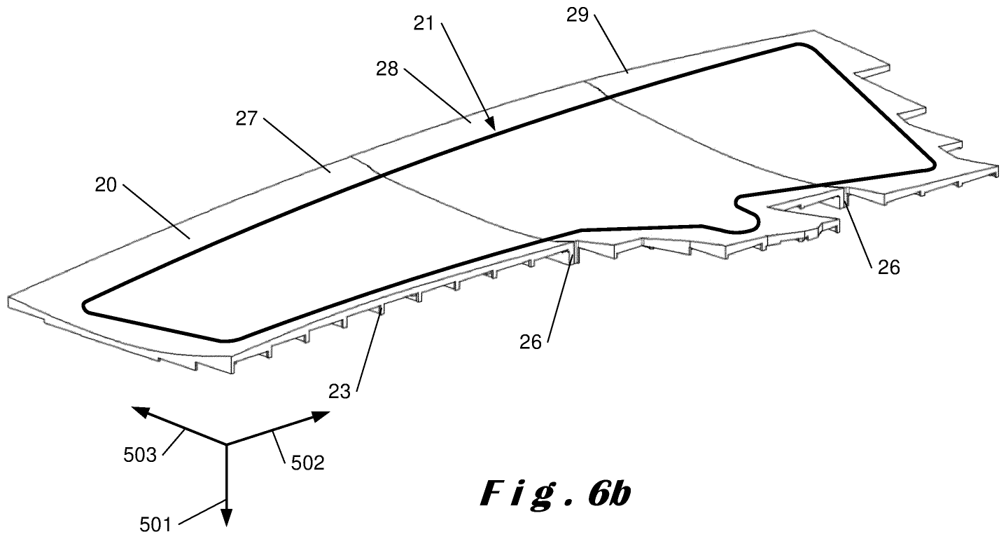

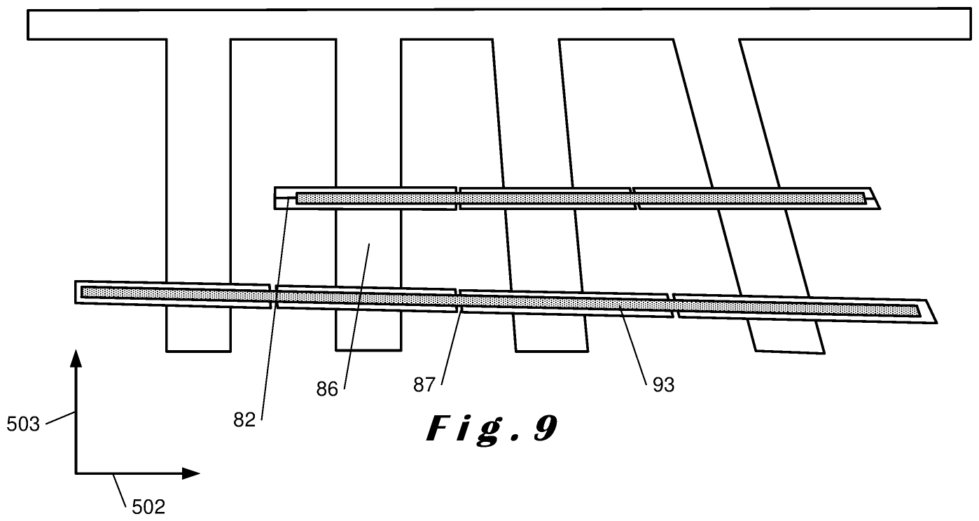

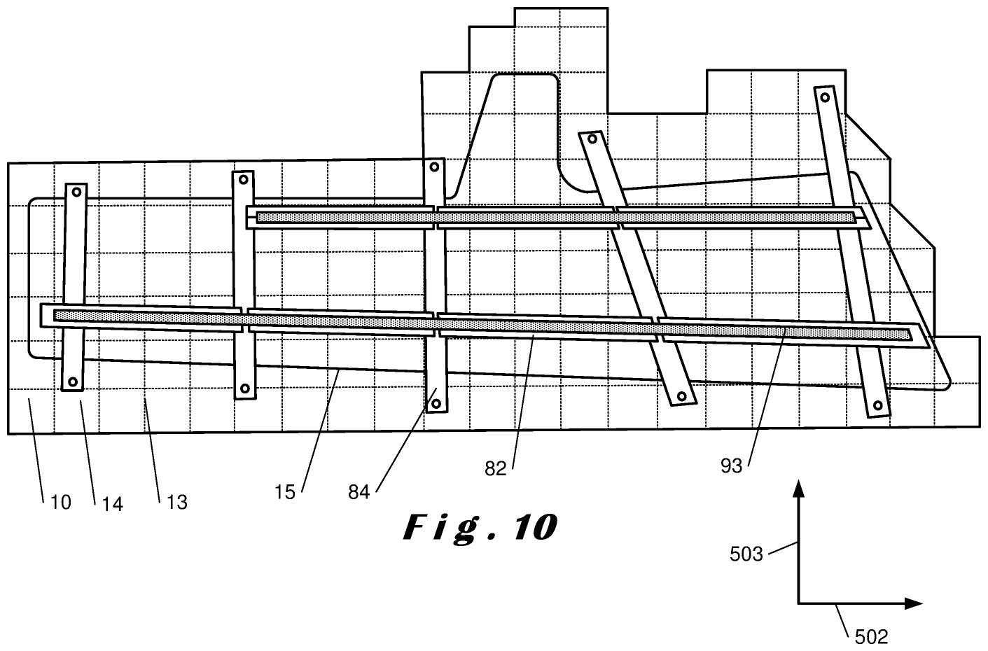

FIG. 6a illustrates the second outer surface 22 of the second shell portion 20 in one embodiment of the disclosure. The protrusions 23 of the second portion 20 are ridges. They delimit facets 24. Similarly, as best seen in FIG. 10, the protrusions 13 of the first portion are ridges which delimit facets 14. The second portion 20 comprises first 27, second 28 and third 29 segments which terminate with flanges 26 at their junctions.

FIG. 6b illustrates the first moulding surface 21 of the second shell portion 20 in one embodiment of the disclosure.

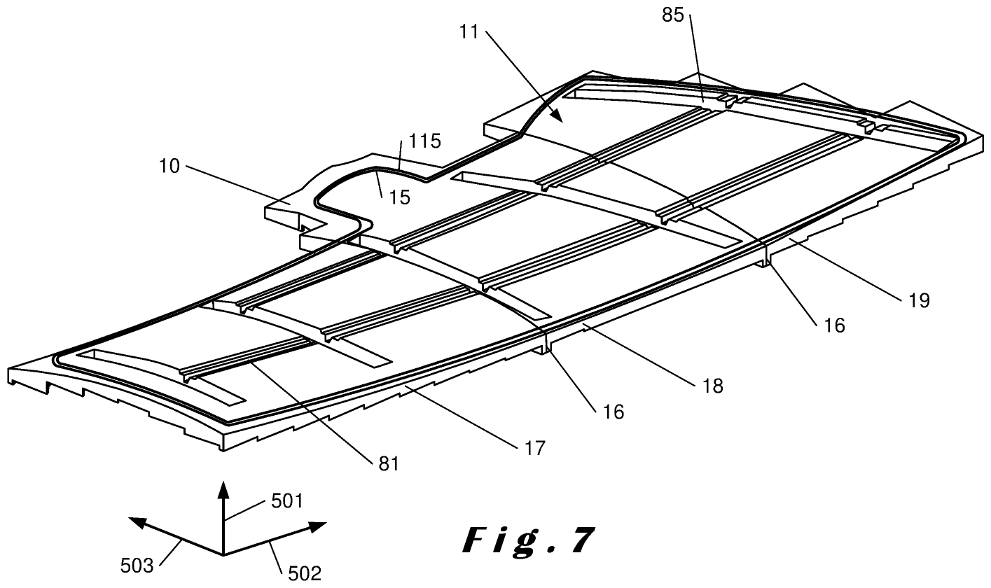

FIG. 7 illustrates the first moulding surface 11 of the first shell portion 10 in one embodiment of the disclosure. The first portion 10 comprises first 17, second 18 and third 19 segments. The periphery 15 of the part 9 is visible on the first moulding surface 11. The mould 1 preferably comprises a seal 115 around the periphery 15.

In one embodiment of the disclosure, the shell 2 comprises cavities 81, preferably in the first moulding surface 11, provided to receive, at least partially, projecting reinforcements 93 (visible in particular in FIG. 11a). Additionally or alternatively, it could comprise some in the second moulding surface 21. The cavities 81 and the projecting reinforcements 93 extend in particular perpendicular to the first direction 501. They extend mainly along the second direction 502. They are not parallel. The main reinforcement 99 and the projecting reinforcements 93 are preformed: they are already shaped before being incorporated into the part 9 during moulding.

The shell 2 preferably comprises grooves 85 of the first moulding surface 11, or possibly of the second moulding surface 12. The grooves 85 are intended to receive arms 84 (visible in FIG. 10). The arms 84 and the grooves 85 preferably extend, at least partially, in the third direction 503.

The projecting reinforcements 93 are preferably inserted, at least partially, into open spaces 83 of inserts 82 that are removable relative to the shell 2, the inserts 82 themselves being at least partially inserted into the cavities 81 (FIG. 8).

The inserts 82 can be carried by arms 84 (visible in FIG. 10) inserted, at least partially, into grooves 85 of the first moulding surface 11, or possibly of the second moulding surface 12.

FIG. 8 also illustrates that the inserts 82 are preferably at least partially inserted into the cavities 81. The inserts 82 are removable relative to the shell 2. They are preferably in two portions 82a, 82b, the open space 83 being between the two portions 82a, 82b. They are intended to carry the projecting reinforcements 93.

FIG. 9 is a schematic top view of the projecting reinforcements 93 during their installation in the inserts 82. A projecting reinforcement 93 can rest on several inserts 82 separated by an intermediate space 87. The inserts 82 can then be carried by a temporary support system 86. The arms 84 pick up the inserts 82 and the projecting reinforcements 93 on the support system 86 while respecting their respective positions, and are placed on the first portion 10 as illustrated in FIG. 10.

FIG. 10 is a schematic top view of the projecting reinforcements 93 and the inserts 82 during their installation on the first portion 10. The protrusions 13 in the form of ridges and the facets 14, which are on the first outer surface 12 of the first portion 10 are also represented therein.

In practice, between the successive mouldings of two parts 9, the shell 2 remains hot, for example around 120°-140°. The shell 2 remains for example at least at 40° C. When the arms 84 carrying the inserts 82 and the projecting reinforcements 93 are placed on the first hot portion 10, the inserts 82 expand and the intermediate spaces 87 disappear.

FIG. 11is a vertical sectional view illustrating a precise positioning of the main reinforcement 99, the inserts 82 and the projecting reinforcements 93 in the first portion 10 before injection.

During injection, the main reinforcement 99 and the projecting reinforcements 93 are located in the space between the moulding surfaces 11, 21 and the resin they contain and which surrounds them is cured so as to polymerize. The tightening device 110 applies, via the bearing system 3, a pressure in the first direction 501 preventing the moulding surfaces 11, 21 from moving apart in the first direction 501. Under the effect of temperature (for example) 160°-180°, the moulding surfaces 11, 21 expand horizontally relative to the bearing system 3 thanks to the slide zones. The projecting reinforcements 93, the main reinforcement 90 and the resin are incorporated into the part 9 during the polymerization of the resin.

Preferably, the heating comprises a period during which the pressure in the first direction 501 is uniformly applied to the shell 2, and at least one other period during which the pressure in the first direction 501 on a shell central zone 2 is different from the pressure on a shell peripheral zone 2. For example, during a first period, the pressure in the first direction 501 can be lower on the central zone than on the peripheral zone to facilitate the injection; during a second period, the pressure in the first direction 501 can be uniform to obtain the desired shape of the part; then, during a third period, the pressure in the first direction 501 can be lower on the central zone than on the peripheral zone to avoid crushing the center of the part. Indeed, during heating, when the resin begins to solidify, the part 9 shrinks and the pressure it exerts on the shell 2 decreases. The decrease in pressure of the mould 1 on the part 9, at least on the central zone of the shell 2, makes it possible to take this phenomenon into account.

Maintaining the periphery 15 of the part 9 (illustrated in FIG. 7) at a higher pressure than the central zone makes it possible to maintain the sealing.

To allow the pressure on part 9 to change over time, the tightening device 110 is configured to be able to change the pressure over time. To allow the spatial adjustment of the pressure on the part 9, the tightening device 110 preferably comprises a central zone and a peripheral zone surrounding the central zone, such that the pressure in the central zone can be different from that in the peripheral zone.

FIG. 11b illustrates the part 9 when the second portion 20 is raised. The arms 84, which remained during the injection, help to handle the part 9 during the demoulding.

FIG. 11c illustrates the part 9 out of the mould 1. The part 9 comprises projecting elements 94 which are formed of the projecting reinforcements 93 and polymerized resin.

In other words, the disclosure relates to a mould 1 for moulding a curved part 9 having a large dimension. The mould 1 comprises a first portion 10, a second portion 20, bearing devices 30, 40, and slide zones located between the first portion 10 and one 30 of the bearing devices 30, 40 and between the second portion 20 and the other 40 of the bearing devices 30, 40. The mould 1 allows the first portion 10 and the second portion 20 to slide horizontally while the bearing devices 30, 40 apply a vertical pressure thereto.

The present disclosure has been described in relation to specific embodiments, which are purely illustrative and should not be construed as limiting. In general, the present disclosure is not limited to the examples illustrated and/or described above. The use of the verbs “comprise”, “include ”, “have”, or any other variant, as well as their conjugations, can in no way exclude the presence of elements other than those mentioned. The use of the indefinite article “a”, “an”, or the definite article “the”, to introduce an element does not exclude the presence of a plurality of these elements. The reference numbers in the claims do not limit their scope.

1. A mould for moulding at least one portion of a curved part, the part having a first part surface and a second part surface separated by a thickness, the mould comprising:
a shell comprising:
a first portion comprising a first moulding surface for moulding the first part surface, and a first outer surface opposite the first moulding surface,
a second portion comprising a second moulding surface for moulding the second part surface, and a second outer surface opposite the second moulding surface, at least one of the first and second outer surfaces being non-planar; and
a bearing system comprising:
a first bearing device mechanically coupled to the first portion and configured to press on the first portion in a first direction, and
a second bearing device mechanically coupled to the second portion and configured to press on the second portion in the first direction;
the mould being configured to allow, between the first portion of the shell and the first bearing device, and between the second portion of the shell and the second bearing device, sliding in at least one direction perpendicular to the first direction.

2. The mould according to claim 1, wherein the mechanical coupling between the first outer surface and the first bearing device comprises protrusions extending from the first outer surface to the first bearing device and/or protrusions extending from the first bearing device to the first outer surface; and the mechanical coupling between the second outer surface and the second bearing device comprises protrusions extending from the second outer surface to the second bearing device and/or protrusions extending from the second bearing device to the second outer surface.

3. The mould according to claim 2, wherein at least some of the protrusions comprise ridges.

4. The mould according to claim 3, comprising heating elements fastened to the first outer surface, and/or to the second outer surface, and/or to the bearing system, and located between protrusions.

5. The mould according to claim 4, wherein the bearing system comprises passages configured to pass a heat transfer fluid.

6. The mould according to claim 5, wherein the mechanical coupling between the first outer surface and the first bearing device and the mechanical coupling between the second outer surface and the second bearing device comprises a first thermal insulation.

7. The mould according claim 6, wherein the sliding between the first portion and the first bearing device occurs over a plurality of first slide zones and the sliding between the second portion and the second bearing device occurs on a plurality of second slide zones, the mould being configured so that a distance in the first direction between the first slide zones and the second slide zones varies by less than 20% over the entire mould.

8. The mould according to claim 7, wherein the first portion comprises a first segment and a second segment assembled by a mechanical fastener outside the first moulding surface and by a weld along the first moulding surface; and/or the second portion comprises a first segment and a second segment assembled by a mechanical fastener outside the second moulding surface and by a weld along the second moulding surface

9. The mould according to claim 8, wherein the shell comprises cavities in the first moulding surface and/or the second moulding surface; the mould comprising removable inserts located in the cavities, each insert comprising an open space intended to receive a projecting reinforcement; the mould comprising removable arms configured to carry the inserts and to be inserted, at least partially, into grooves of the first moulding surface, and/or of the second moulding surface.

10. A moulding system comprising a mould according to claim 9, a tightening device, and a resin injection system configured to inject a resin between the first moulding surface and the second moulding surface.

11. A moulding method comprising heating a resin and a main reinforcement in a mould according to claim 1, so as to mould a composite part, incorporating the main reinforcement and resin, and whose first part surface is moulded against the first moulding surface and second part surface is moulded against the second moulding surface, while resin is injected between the first moulding surface and the second moulding surface, and that a pressure in the first direction is applied via the bearing system.

12. The method according to claim 11, wherein the part comprises an airfoil panel for an aircraft wing, an aircraft empennage, an aircraft fuselage panel, an aircraft airfoil flap, an aircraft fairing or an aircraft engine part.

13. A moulding method comprising heating a resin and a main reinforcement in a mould, so as to mould a composite part, incorporating the main reinforcement and resin, and whose first part surface is moulded against the first moulding surface and second part surface is moulded against the second moulding surface, while resin is injected between the first moulding surface and the second moulding surface, and that a pressure in the first direction is applied via the bearing system, wherein the mould is a mould according to claim 9, the method comprising, prior to the resin injection, inserting the inserts into the cavities and inserting protruding reinforcements into the open spaces, so that the protruding reinforcements, the main reinforcement and the resin are united by the moulding so as to form a piece.

14. The method according to claim 13, wherein the shell is at a temperature above 40° C. when the inserts are inserted into the cavities.

15. The method according to claim 14, wherein the heating takes place during:
a period during which the pressure in the first direction is uniform over the entire shell, and
at least one other period during which the pressure in the first direction on a central shell zone is different from the pressure on a peripheral shell zone.

16. The method according to claim 11, wherein the heating takes place during:
a period during which the pressure in the first direction is uniform over the entire shell, and
at least one other period during which the pressure in the first direction on a central shell zone is different from the pressure on a peripheral shell zone.

17. The method according to claim 12, wherein the heating takes place during:
a period during which the pressure in the first direction is uniform over the entire shell, and
at least one other period during which the pressure in the first direction on a central shell zone is different from the pressure on a peripheral shell zone.

18. The method according to claim 13, wherein the heating takes place during:
a period during which the pressure in the first direction is uniform over the entire shell, and
at least one other period during which the pressure in the first direction on a central shell zone is different from the pressure on a peripheral shell zone.
